(19) United States
(12) Patent Application Publication
(10) Pub. No.: US 2009/0187402 A1
(43) Pub. Date: Jul. 23, 2009

(54) Performance Prediction For An Interactive Speech Recognition System

(75) Inventor: Holger Scholl, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,709

(22) PCT Filed: May 24, 2005
(86) PCT No.: PCT/IB2005/051687

§ 371 Date: Nov. 28, 2006

(30) Foreign Application Priority Data
Jun. 4, 2004 (EP) 04102513.1

(51) Int. Cl. G10L 15/20

(52) U.S. Cl. 704/233; 704/E15.039

(57) ABSTRACT

The present invention provides an interactive speech recognition system and a corresponding method for determining a performance level of a speech recognition procedure on the basis of recorded background noise. The inventive system effectively exploits speech pauses that occur before the user enters speech that becomes subject to speech recognition. Preferably, the inventive performance prediction makes effective use of trained noise classification models. Moreover, predicted performance levels are indicated to the user in order to give a reliable feedback of the performance of the speech recognition procedure. In this way the interactive speech recognition system may react to noise conditions that are inappropriate for generating reliable speech recognition.

The present invention relates to the field of interactive speech recognition.

The performance and reliability of automatic speech recognition systems (ASR) strongly depends on the characteristics and level of background noise. There exist several approaches to increase system performance and to cope with a variety of different noise conditions. A general idea is based on noise reduction and noise suppression methods in order to increase the signal to noise ratio (SNR) between speech and noise. Principally, this can be realized by means of appropriate noise filters.

Other approaches focus on noise classification models that are specific for particular background noise scenarios. Such noise classification models may be incorporated into acoustic models or language models for the automatic speech recognition and require a training under the particular noise condition. Hence, by means of noise classification models a speech recognition process can be adapted to various predefined noise scenarios. Moreover, explicit noise robust acoustic modeling that incorporates a-priori knowledge into a classification model can be applied.

However, all these approaches either try to improve a quality of speech or to match various noise conditions as they might occur in typical application scenarios. Irrespective of the variety and quality of these noise classification models the vast number of unpredictable noise and perturbation scenarios cannot be covered by means of reasonable noise reduction and/or noise matching efforts.

It is therefore of practical use to indicate to the user of the automatic speech recognition system the momentary noise level such that the user becomes aware of a problematic recording environment that may lead to erroneous speech recognition. Most typically, noise indicators display the momentary energy level of a microphone input and the user himself can assess whether the indicated level is in a suitable region that allows for a sufficient quality of speech recognition.

For example WO 02/095726 A1 discloses such a speech quality indication. Here, a received speech signal is fed to a speech quality evaluator that quantifies the signal's speech quality. The resultant speech quality measure is fed to an indicator driver which generates an appropriate indication of the currently received speech quality. This indication is made apparent to a user of a voice communications device by an indicator. The speech quality evaluator may quantify speech quality in various ways. Two simple examples of speech quality measures which may be employed are (i) the speech signal level (ii) the speech signal to noise ratio.

Levels of speech signals and signal to noise ratios that are displayed to a user might be adapted to indicate a problematic recording environment but are principally not directly related to a speech recognition performance of the automatic speech recognition system. When for example a particular noise signal can be sufficiently filtered, a rather low signal to noise ratio not necessarily has to be correlated to a low performance of the speech recognition system. Additionally, solutions known in the prior art are typically adapted to generate indication signals that are based on a currently received speech quality. This often implies that a proportion of received speech has already been subject to a recognition procedure. Hence, generation of a speech quality measure is typically based on recorded speech and/or speech signals that have already been subject to a speech recognition procedure. In both cases at least a proportion of speech has already been processed before the user has a chance of improving the recording conditions or reducing the noise level.

The present invention provides an interactive speech recognition system for recognizing speech of a user. The inventive speech recognition system comprises means for receiving acoustic signals comprising a background noise, means for selecting a noise model on the basis of the received acoustic signals, means for predicting of a performance level of a speech recognition procedure on the basis of the selected noise model and means for indicating the predicted performance level to the user. In particular, the means for receiving the acoustic signals are designed for recording noise levels preferably before a user provides any speech signals to the interactive speech recognition system. In this way acoustic signals that are indicative of the background noise are obtained even before speech signals are generated, that become subject to a speech recognition procedure. Especially in dialogue systems appropriate speech pauses occur at some predefined point of time and can effectively be exploited in order to record noise specific acoustic signals.

The inventive interactive speech recognition system is further adapted to make use of noise classification models that were trained under particular application conditions of the speech recognition system. Preferably, the speech recognition system has access to a variety of noise classification models, each of which being indicative of a particular noise condition. Selecting of a noise model typically refers to analysis of the received acoustic signals and comparison with the stored previously trained noise models. That particular noise model that matches best the received and analyzed acoustic signals is then selected.

Based on this selected noise model a performance level of the speech recognition procedure is predicted. The means for predicting of the performance level therefore provide an estimation of a quality measure of the speech recognition procedure even before the actual speech recognition has started. This provides an effective means to estimate and to recognize a particular noise level as early as possible in a sequence of speech recognition steps. Once a performance level of a speech recognition procedure has been predicted, the means for indicating are adapted to inform the user of the predicted performance level.

Especially by indicating an estimated quality measure of a speech recognition process to a user, the user might be informed as early as possible of insufficient speech recognition conditions. In this way the user can react to insufficient speech recognition conditions even before he actually makes use of the speech recognition system. Such a functionality is particularly advantageous in dialogue systems where a user acoustically enters control commands or requests. Therefore, the inventive speech recognition system is preferably implemented into an automatic dialogue system that is adapted to processes spoken input of a user and to provide requested information, such as e.g. a public transport timetable information system.

According to a further preferred embodiment of the invention, the means for predicting of the performance level are further adapted to predict the performance level on the basis of noise parameters that are determined on the basis of the received acoustic signals. These noise parameters are for example indicative of a speech recording level or a signal to noise ratio level and can be further exploited for prediction of the performance level of the speech recognition procedure. In this way the invention provides effective means for combining application of noise classification models with generic noise specific parameters into a single parameter, namely the performance level that is directly indicative of the speech recognition performance of the speech recognition system.

Alternatively, the means for predicting of the performance level may make separate use of either noise models or noise parameters. However, by evaluating a selected noise model in combination with separately generated noise parameters a more reliable performance level is to be expected. Hence, the means for predicting of the performance level may universally make use of a plurality of noise indicative input signals in order to provide a realistic performance level that is directly indicative of a specific error rate of a speech recognition procedure.

According to a further preferred embodiment of the invention, the interactive speech recognition system is further adapted to tune at least one speech recognition parameter of the speech recognition procedure on the basis of the predicted performance level. In this way the predicted performance level is not only used for providing the user with appropriate performance information but also to actively improve the speech recognition process. A typical speech recognition parameter is for example the pruning level that specifies the effective range of relevant phoneme sequences for a language recognition process that is typically based on statistical procedures making use of e.g. hidden Markov models (HMM).

Typically, increasing of a pruning level leads to a decrease of an error rate but requires a remarkably higher computational power that in turn slows down the process of speech recognition. Error rates may for example refer to word error rate (WER) or concept error rate (CER). By tuning speech recognition parameters on the basis of a predicted performance level, the speech recognition procedure can be universally modified in response to its expected performance.

According to a further preferred embodiment, the interactive speech recognition system further comprises means for switching a predefined interaction mode on the basis of the predicted performance level. Especially in dialogue systems there exists a plurality of interaction and communication modes of a speech recognition and/or dialogue system. In particular, speech recognition systems and/or dialogue systems might be adapted to reproduce recognized speech and to provide the recognized speech to the user that in turn has to confirm or to reject the result of the speech recognition process.

The triggering of such verification prompts can be effectively governed by means of the predicted performance level. For example, in case of a bad performance level verification prompts might be triggered very frequently, whereas in case of a high performance level such verification prompts might be inserted very seldom in a dialogue. Other interaction modes may comprise a complete rejection of a received sequence of speech. This is particularly reasonable in very bad noise conditions. In this case the user might simply be instructed to reduce the background noise level or to repeat a sequence of speech. Alternatively, when inherently switching to a higher pruning level requiring more computation time in order to compensate an increased noise level, the user may simply be informed of a corresponding delay or reduced performance of the speech recognition system.

According to a further preferred embodiment of the invention, the means for receiving the acoustic signals are further adapted to record background noise in response to receive an activation signal that is generated by an activation module. The activation signal generated by the activation module triggers the means for receiving the acoustic signals. Since the means for receiving the acoustic signals are preferably adapted to record background noise prior to occurrence of utterances of the user, the activation module tries to selectively trigger the means for receiving the acoustic signals when an absence of speech is expected.

This can be effectively realized by an activation button to be pressed by the user in combination with a readiness indicator. By pressing the activation button, the user switches the speech recognition system into attendance and after a short delay the speech recognition system indicates its readiness. Within this delay it can be assumed that the user does not speak yet. Therefore, the delay between pressing of an activation button and indicating a readiness of the system can be effectively used for measuring and recording momentary background noise.

Alternatively, pressing of the activation button may also be performed on a basis of voice control. In such an embodiment, the speech recognition system is in continuous listening mode that is based on a separate robust speech recognizer especially adapted to catch particular activation phrases. Also here the system is adapted not to respond immediately to a recognized activation phrase but to make use of a predefined delay for gathering of background noise information.

Additionally, when implemented into a dialogue system a speech pause typically occurs after a greeting message of the dialogue system. Hence, the inventive speech recognition system effectively exploits well defined or artificially generated speech pauses in order to sufficiently determine the underlying background noise. Preferably, determination of background noise is incorporated by making use of natural speech pauses or speech pauses that are typical for speech recognition and/or dialogue systems, such that the user is not aware of the background noise recording step.

According to a further preferred embodiment of the invention, the means for indicating the predicted performance to the user are adapted to generate an audible and/or visual signal that indicates the predicted performance level. For example, the predicted performance level might be displayed to a user by means of a color encoded blinking or flashing of e.g. an LED. Different colors like green, yellow, red may indicate good, medium, or low performance level. Moreover, a plurality of light spots may be arranged along a straight line and the level of performance might be indicated by the number of simultaneously flashing light spots. Additionally, the performance level might be indicated by a beeping tone and in a more sophisticated environment the speech recognition system may audibly instruct the user via predefined speech sequences that can be reproduced by the speech recognition system. The latter is preferably implemented in speech recognition based dialogue systems that are only accessible via e.g. telephone. Here, in case of a low predicted performance level, the interactive speech recognition system may instruct the user to reduce noise level and/or to repeat the spoken words.

In another aspect, the invention provides a method of interactive speech recognition that comprises the steps of receiving acoustic signals that comprise background noise, selecting a noise model of a plurality of trained noise models on the basis of the received acoustic signals, predicting a performance level of a speech recognition procedure on the basis of the selected noise model and indicating the predicted performance level to a user.

According to a further preferred embodiment of the invention, each one of the trained noise models is indicative of a particular noise and is generated by means of a first training procedure that is performed under a corresponding noise condition. This requires a dedicated training procedure for generation of the plurality of noise models. For example, adapting the inventive speech recognition system to an automotive environment, a corresponding noise model has to be trained under automotive condition or at least simulated automotive conditions.

According to a further preferred embodiment of the invention, prediction of the performance level of the speech recognition procedure is based on a second training procedure. The second training procedure serves to train the predicting of performance levels on the basis of selected noise conditions and selected noise models. Therefore, the second training procedure is adapted to monitor a performance of the speech recognition procedure for each noise condition that corresponds to a particular noise model that is generated by means of the first training procedure. Hence, the second training procedure serves to provide trained data being representative of a specific error rate, like e.g. WER or CER of the speech recognition procedure that have been measured under a particular noise condition where the speech recognition made use of a respective noise model.

In another aspect, the invention provides a computer program product for an interactive speech recognition system. The inventive computer program product comprises computer program means that are adapted for receiving acoustic signals comprising background noise, selecting a noise model on the basis of the received acoustic signals, calculating of a performance level of a speech recognition procedure on the basis of the selected noise model and indicating the predicted performance level to the user.

In still another aspect, the invention provides a dialogue system for providing a service to a user by processing of a speech input generated by the user. The dialogue system comprises an inventive interactive speech recognition system. Hence, the inventive speech recognition system is incorporated as an integral part into a dialogue system, such as e.g. an automatic timetable information system providing information of public transportation.

Further, it is to be noted that any reference sign in the claims are not to be construed as limiting the scope of the present invention.

In the following preferred embodiments of the invention will be described in detail by making reference to the drawings in which:

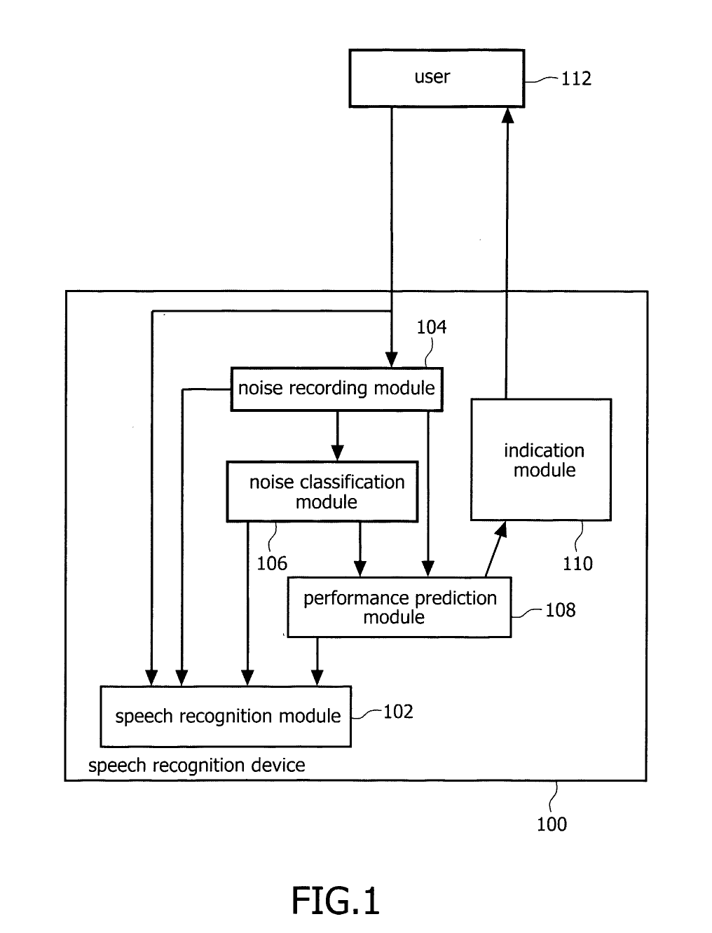

FIG. 1 shows a block diagram of the speech recognition system,

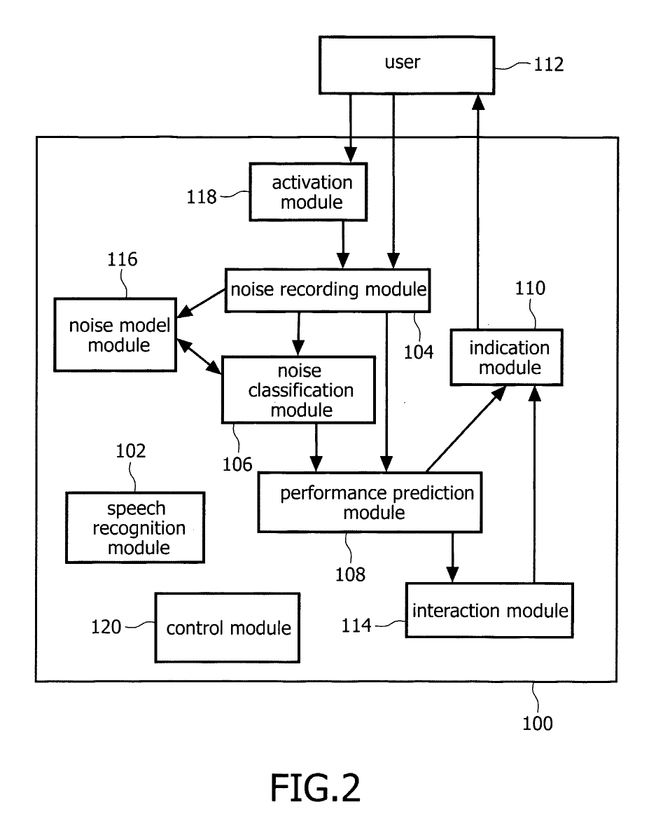

FIG. 2 shows a detailed block diagram of the speech recognition system,

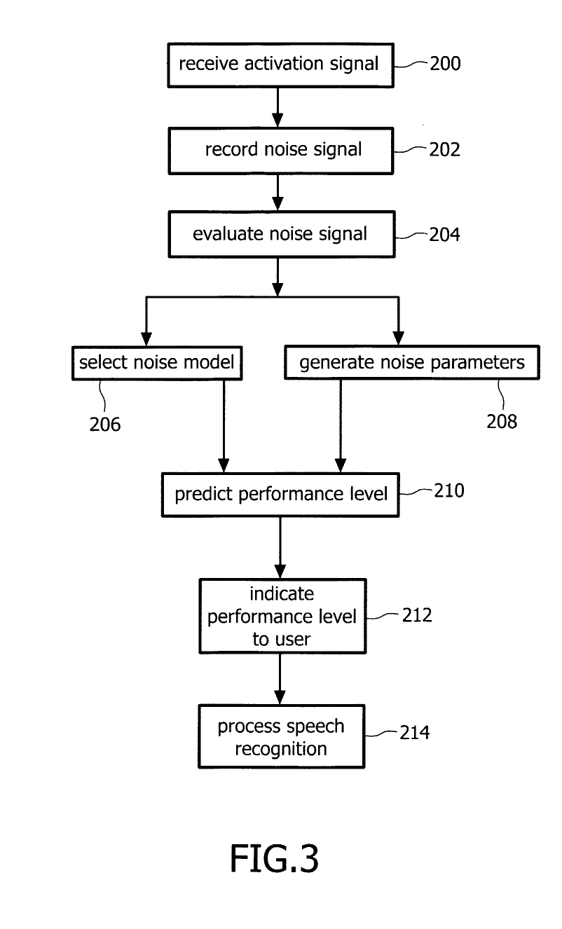

FIG. 3 illustrates a flow chart for predicting a performance level of the speech recognition system,

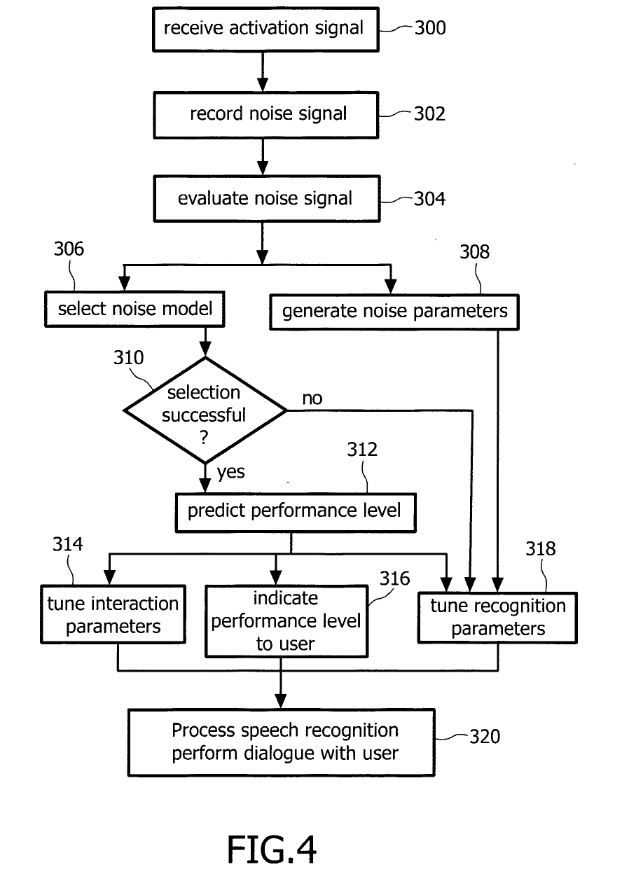

FIG. 4 illustrates a flow chart wherein performance level prediction is incorporated into speech recognition procedure.

FIG. 1 shows a block diagram of the inventive interactive speech recognition system 100. The speech recognition system has a speech recognition module 102, a noise recording module 104, a noise classification module 106, a performance prediction module 108 and an indication module 110. A user 112 may interact with the speech recognition system 100 by providing speech that is be recognized by the speech recognition system 100 and by receiving feedback being indicative of the performance of the speech recognition via the indication module 110.

The single modules 102 . . . 110 are designed for realizing a performance prediction functionality of the speech recognition system 100. Additionally, the speech recognition system 100 comprises standard speech recognition components that are not explicitly illustrated but are known in the prior art.

Speech that is provided by the user 112 is inputted into the speech recognition system 100 by some kind of recording device like e.g. a microphone that transforms an acoustic signal into a corresponding electrical signal that can be processed by the speech recognition system 100. The speech recognition module 102 represents the central component of the speech recognition system 100 and provides analysis of recorded phonemes and performs a mapping to word sequences or phrases that are provided by a language model. In principle any speech recognition technique is applicable with the present invention. Moreover, speech inputted by the user 112 is directly provided to the speech recognition module 102 for speech recognition purpose.

The noise recording and noise classification modules 104, 106 as well as the performance prediction module 108 are designed for predicting the performance of the speech recognition process that is executed by the speech recognition module 102 solely on the basis of recorded background noise. The noise recording module 104 is designed for recording background noise and to provide recorded noise signals to the noise classification module 106. For example, the noise recording module 104 records a noise signal during a delay of the speech recognition system 100. Typically, the user 112 activates the speech recognition system 100 and after a predefined delay interval has passed, the speech recognition system indicates its readiness to the user 112. During this delay it can be assumed that the user 112 simply waits for the readiness state of the speech recognition system and does therefore not produce any speech. Hence, it is expected that during the delay interval the recorded acoustic signals are exclusively representative of background noise.

After recording of the noise by means of the noise recording module 104, the noise classification module serves to identify the recorded noise signals. Preferably, the noise classification module 106 makes use of noise classification models that are stored in the speech recognition system 100 and that are specific for various background noise scenarios. These noise classification models are typically trained under corresponding noise conditions. For example, a particular noise classification model may be indicative of automotive background noise. When the user 112 makes use of the speech recognition system 100 in an automotive environment, a recorded noise signal is very likely to be identified as automotive noise by the noise classification module 106 and the respective automotive noise classification model might be selected. Selection of a particular noise classification model is also performed by means of the noise classification module 106. The noise classification module 106 may further be adapted to extract and to specify various noise parameters like noise signal level or signal to noise ratio.

Generally, the selected noise classification module as well as other noise specific parameters determined and selected by the noise classification module 106 are provided to the performance prediction module 108. The performance prediction module 108 may further receive unaltered recorded noise signals from the noise recording module 104. The performance prediction module 108 then calculates an expected performance of the speech recognition module 102 on the basis of any of the provided noise signals, noise specific parameters or selected noise classification model. Moreover, the performance prediction module 108 is adapted to determine a performance prediction by making use of various of the provided noise specific inputs. For example, the performance prediction module 108 effectively combines a selected noise classification module and a noise specific parameter in order to determine a reliable performance prediction of the speech recognition process. As a result, the performance prediction module 108 generates a performance level that is provided to the indication module 110 and to the speech recognition module 102.

By means of providing a determined performance level of the speech recognition process to the indication module 110 the user 112 can be effectively informed of the expected performance and reliability of the speech recognition process. The indication module 110 may be implemented in a plurality of different ways. It may generate a blinking, color encoded output that has to be interpreted by the user 112. In a more sophisticated embodiment, the indication module 110 may also be provided with speech synthesizing means in order to generate audible output to the user 112 that even instructs the user 112 to perform some action in order to improve the quality of speech and/or to reduce the background noise, respectively.

The speech recognition module 102 is further adapted to directly receive input signals from the user 112, recorded noise signals from the noise recording module 104, noise parameters and selected noise classification model from the noise classification module 106 as well as a predicted performance level of the speech recognition procedure from the performance prediction module 108. By providing any of the generated parameters to the speech recognition module 102 not only the expected performance of the speech recognition process can be determined but also the speech recognition process itself can be effectively adapted to the present noise situation.

In particular, by providing the selected noise model and associate noise parameters to the speech recognition module 102 by the noise classification module 106 the underlying speech recognition procedure can effectively make use of the selected noise model. Furthermore, by providing the expected performance level to the speech recognition module 102 by means of the performance prediction module 108, the speech recognition procedure can be appropriately tuned. For example when a relatively high error rate has been determined by means of the performance prediction module 108, the pruning level of the speech recognition procedure can be adaptively tuned in order to increase the reliability of the speech recognition process. Since shifting of the pruning level towards higher values requires appreciable additional computation time, the overall efficiency of the underlying speech recognition process may substantially decrease. As a result the entire speech recognition process becomes more reliable at the expense of slowing down. In this case it is reasonable to make use of the indication module 110 to indicate this kind of lower performance to the user 112.

FIG. 2 illustrates a more sophisticated embodiment of the interactive speech recognition system 100. In comparison to the embodiment shown in FIG. 1, FIG. 2 illustrates additional components of the interactive speech recognition system 100. Here, the speech recognition system 100 further has an interaction module 114, a noise module 116, an activation module 118 and a control module 120. Preferably, the speech recognition module 102 is connected to the various modules 104 . . . 108 as already illustrated in FIG. 1. The control module 120 is adapted to control an interplay and to coordinate the functionality of the various modules of the interactive speech recognition system 100.

The interaction module 114 is adapted to receive the predicted performance level from the performance prediction module 108 and to control the indication module 110. Preferably, the interaction module 114 provides various interaction strategies that can be applied in order to communicate with the user 112. For example, the interaction module 114 is adapted to trigger verification prompts that are provided to the user 112 by means of the indication module 110. Such verification prompts may comprise a reproduction of recognized speech of the user 112. The user 112 then has to confirm or to discard the reproduced speech depending on whether the reproduced speech really represents the semantic meaning of the user's original speech.

The interaction module 114 is preferably governed by the predicted performance level of the speech recognition procedure. Depending on the level of the predicted performance, the triggering of verification prompts may be correspondingly adapted. In extreme cases where the level of the performance indicates that a reliable speech recognition is not possible, the interaction module 114 may even trigger the indication module 110 to generate an appropriate user instruction, like e.g. instructing the user 112 to reduce background noise.

The noise model module 116 serves as a storage of the various noise classification models. The plurality of different noise classification models is preferably generated by means of corresponding training procedures that are performed under respective noise conditions. In particular, the noise classification module 106 accesses the noise model module 116 for selection of a particular noise model. Alternatively, selection of a noise model may also be realized by means of the noise model module 116. In this case the noise model module 116 receives recorded noise signals from the noise recording module 104, compares a proportion of the received noise signals with the various stored noise classification modules and determines at least one of the noise classification models that matches the proportion of the recorded noise. The best fitting noise classification model is then provided to the noise classification module 106 that may generate further noise specific parameters.

The activation module 118 serves as a trigger for the noise recording module 104. Preferably, the activation module 118 is implemented as a specific designed speech recognizer that is adapted to catch certain activation phrases that are spoken by the user. In response to receive an activation phrase and respective identification of the activation phrase, the activation module 118 activates the noise recording module 104. Additionally, the activation module 118 also triggers the indication module 110 via the control module 120 in order to indicate a state of readiness to the user 112. Preferably, indication of the state of readiness is performed after the noise recording module 104 has been activated. During this delay it can be assumed that the user 112 does not speak but waits for the readiness of the speech recognition system 100. Hence, this delay interval is ideally suited to record acoustic signals that are purely indicative of the actual background noise.

Instead of implementing the activation module 118 by making use of a separate speech recognition module, the activation module may also be implemented by some other kind of activation means. For example, the activation module 118 may provide an activation button that has to be pressed by the user 112 in order to activate the speech recognition system. Also here a required delay for recording the background noise can be implemented correspondingly. Especially when the interactive speech recognition system is implemented into a telephone based dialogue system, the activation module 118 might be adapted to activate a noise recording after some kind of message of the dialogue system has been provided to the user 112. Most typically, after providing a welcome message to the user 112 a suitable speech pause arises that can be exploited for background noise recording.

FIG. 3 illustrates a flow chart for predicting the performance level of the inventive interactive speech recognition system. In a first step 200 an activation signal is received. The activation signal may refer to the pressing of a button by a user 112, by receiving an activation phrase that is spoken by the user or after providing a greeting message to the user 112 when implemented into a telephone based dialogue system. In response of receiving the activation signal in step 200, in the successive step 202 a noise signal is recorded. Since the activation signal indicates the start of a speechless period the recorded signals are very likely to uniquely represent background noise. After the background noise has been recorded in step 202 in the following step 204 the recorded noise signals are evaluated by means of the noise classification module 106. Evaluation of the noise signals refers to selection of a particular noise model in step 206 as well as generating of noise parameters in step 208. By means of the steps 206, 208 a particular noise model and associate noise parameters are determined.

Based on the selected noise model and on the generated noise parameters in the following step 210 the performance level of the speech recognition procedure is predicted by means of the performance prediction module 108. The predicted performance level is then indicated to the user in step 212 by making use of the indication module 110. Thereafter or simultaneously the speech recognition is processed in step 214. Since the prediction of the performance level is based on noise input that is prior to input of speech, in principle, a predicted performance level can be displayed to the user 112 even before the user starts to speak.

Moreover, the predicted performance level may be generated on the basis of an additional training procedure that provides a relation between various noise models and noise parameters and a measured error rate. Hence the predicted performance level focuses on the expected output of a speech recognition process. The predicted and expected performance level is preferably not only indicated to the user but is preferably also exploited by the speech recognition procedure in order to reduce the error rate.

FIG. 4 is illustrative of a flow chart for making use of a predicted performance level within a speech recognition procedure. Steps 300 to 308 correspond to steps 200 through 208 as they are illustrated already in FIG. 3. In step 300 the activation signal is received, in step 302 a noise signal is recorded and thereafter in step 304 the recorded noise signal is evaluated. Evaluation of noise signals refers to the two steps 306 and 308 wherein a particular noise classification model is selected and wherein corresponding noise parameters are generated. Once noise specific parameters have been generated in step 308 the generated parameters are used to tune the recognition parameters of the speech recognition procedure in step 318. After the speech recognition parameters like e.g. pruning level have been tuned in step 318, the speech recognition procedure is processed in step 320 and when implemented into a dialogue system corresponding dialogues are also performed in step 320. Generally, steps 318 and steps 320 represent a prior art solution of exploiting noise specific parameters for improving of a speech recognition process. Steps 310 through 316 in contrast represent the inventive performance prediction of the speech recognition procedure that is based on the evaluation of background noise.

After the noise model has been selected in step 306, step 310 checks whether the performed selection has been successful. In case that no specific noise model could be selected, the method continues with step 318 wherein determined noise parameters are used to tune the recognition parameters of the speech recognition procedure. In case that in step 310 successful selection of a particular noise classification model has been confirmed, the method continues with step 312 where on the basis of the selected noise model the performance level of the speech recognition procedure is predicted. Additionally, prediction of the performance level may also incorporate exploitation of noise specific parameters that have been determined in step 308. After the performance level has been predicted in step 312, steps 314 through 318 are simultaneously or alternatively executed.

In step 314 interaction parameters for the interaction module 114 are tuned with respect to the predicted performance level. These interaction parameters specify the time intervals after which verification prompts in a dialogue system have to be triggered. Alternatively, the interaction parameters may specify various interaction scenarios between the interactive speech recognition system and the user. For example, an interaction parameter may govern that the user has to reduce the background noise before a speech recognition procedure can be performed. In step 316 the determined performance level is indicated to the user by making use of the indication module 110. In this way the user 112 effectively becomes aware of the degree of performance and hence the reliability of the speech recognition process. Additionally, the tuning of the recognition parameters which is performed in step 318 can effectively exploit the performance level that is predicted in step 312.

Steps 314, 316, 318 may be executed simultaneously, sequentially or only selectively. Selective execution refers to the case wherein only one or two of the steps 314, 316, 318 is executed. However, after execution of any of the steps 314, 316, 318 the speech recognition process is performed in step 320.

The present invention therefore provides an effective means for estimating a performance level of a speech recognition procedure on the basis of recorded background noise. Preferably, the inventive interactive speech recognition system is adapted to provide an appropriate performance feedback to the user 112 even before speech is inputted into the recognition system. Since exploitation of a predicted performance level can be realized in a plurality of different ways, the inventive performance prediction can be universally implemented into various existing speech recognition systems. In particular, the inventive performance prediction can be universally combined with existing noise reducing and/or noise level indicating systems.

### LIST OF REFERENCE NUMERALS

100 speech recognition system
102 speech recognition module
104 noise recording module
106 noise classification module
108 performance prediction module
110 indication module
112 user
114 interaction module
116 noise model module
118 activation module
120 control module

1. An interactive speech recognition system (100) for recognizing speech of a user (112), the speech recognition system comprising:
means for receiving acoustic signals comprising a background noise,
means for selecting a noise model (106) on the basis of the received acoustic signals,
means for predicting of a performance level (108) of a speech recognition procedure on the basis of the selected noise model,
means for indicating (110) the predicted performance level to the user.

2. The interactive speech recognition system (100) according to claim 1, wherein the means for predicting of the performance level (108) being further adapted to predict the performance level on the basis of noise parameters being determined on the basis of the received acoustic signals,

3. The interactive speech recognition system (100) according to claim 1, further being adapted to tune at least one speech recognition parameter of the speech recognition procedure on the basis of the predicted performance level.

4. The interactive speech recognition system (100) according to claim 1, further comprising means for switching a predefined interaction mode (114) on the basis of the predicted performance level.

5. The interactive speech recognition system (100) according to claim 1, wherein the means for predicting of the performance level (108) being adapted to predict the performance level prior to the execution of the speech recognition procedure.

6. The interactive speech recognition system (100) according to claim 1, wherein the means for receiving the acoustic signals being further adapted to record background noise in response to receive an activation signal being generated by an activation module (118).

7. The interactive speech recognition system (100) according to claim 1, wherein the means for indicating (110) the predicted performance to the user (116) being adapted to generate an audible and/or visual signal indicating the predicted performance level.

8. A method of interactive speech recognition comprising the steps of:
receiving acoustic signals comprising background noise,
selecting a noise model of a plurality of trained noise models on the basis of the received acoustic signals,
predicting a performance level of a speech recognition procedure on the basis of the selected noise model,
indicating the predicted performance level to a user.

9. The method according to claim 8, further comprising generating each of the noise models by making use of a first training procedure under corresponding noise conditions.

10. The method according to claim 8, wherein prediction of the performance level of the speech recognition procedure being based on a second training procedure, the second training procedure being adapted to monitor a performance of the speech recognition procedure for each one of the noise conditions.

11. A computer program product for an interactive speech recognition system comprising computer program means being adapted for:
receiving acoustic signals comprising background noise,
selecting a noise model on the basis of the received acoustic signals,
calculating of a performance level of a speech recognition procedure on the basis of the selected noise model,
indicating the predicted performance level to the user.

12. An automatic dialogue system comprising an interactive speech recognition system according to claim 1.
